(19) United States
(12) Patent Application Publication
(10) Pub. No.: US 2024/0261758 A1
(43) Pub. Date: Aug. 8, 2024

(54) Spherical Metal-Organic Frameworks Using Alginate

(71) Applicant: ExxonMobil Technology and Engineering Compnay, Annandale, NJ (US)

(72) Inventors: Wesley Sattler, Parsippany, NJ (US); Nicole M. Herb, Allentown, NJ (US); Aaron W. Peters, New Hope, NJ (US); Matthew T. Kapelewski, Lambertville, NJ (US)

(21) Appl. No.: 18/561,633

(22) PCT Filed: May 23, 2022
(86) PCT No.: PCT/US2022/030581

§ 371 Date: Nov. 16, 2023

Related U.S. Application Data
(60) Provisional application No. 63/192,263, filed on May 24, 2021.

(51) Int. Cl. B01J 20/22; B01D 53/02; B01J 20/28; B01J 20/30

(52) U.S. Cl. CPC B01J 20/226; B01D 53/02; B01J 20/28011; B01J 20/28019; B01J 20/2803; B01J 20/28061; B01J 20/28064; B01J 20/28066; B01J 20/3042; B01J 20/3085; B01D 2253/204; B01D 2257/504

(57) ABSTRACT

Provided herein are methods of making the present metal-organic framework spheres and novel compositions produced by the same. In the present methods, sodium alginate and water are mixed to produce an aqueous sodium alginate solution. Metal-organic frameworks are added to the aqueous sodium alginate solution to produce an aqueous metal-organic framework alginate mixture. A calcium chloride solution is added to the metal-organic framework alginate mixture is added to form the metal-organic framework sphere. The metal-organic framework sphere produced has about 70 wt. % of metal-organic frameworks or less and a network of calcium alginate complexes and can withstand a crush strength of at least 44.5 N.

### CROSS REFERENCE TO RELATED APPLICATIONS

The present application claims priority to and the benefit of U.S. Provisional Application No. 63/192,263 filed on May 24, 2021, which is/are hereby incorporated by reference in its/their entirety.

### FIELD

The present disclosure generally relates to making metal-organic framework composites, and specifically relates to methods of making metal-organic framework spheres having a crush strength of at least 10 lb. force (44.5 Newtons).

### BACKGROUND

Metal-organic frameworks have application as adsorbents in separation technologies and catalysts and/or catalyst supports. When synthesized, metal-organic frameworks are produced as microcrystalline or nano-powders. The powder is then formed into shaped bodies potentially having small particle size distributions for use in the various applications.

To shape the metal-organic frameworks, techniques such as pelletization and extrusion include pressing and crushing the metal-organic framework particles into a particle size fraction. High pressures for such techniques are often too harsh for the metal-organic framework materials and can lead to significant reduction in the porosity and surface area of the shaped material. Ideally, shaping must be performed without a significant reduction in gravimetric surface area, porosity, chemical structure, or functionality.

Other methods include shaping the metal-organic frameworks with pastes for either extrusion or drying. These preparations often require additives and/or binders such as cellulose or polymers (polyvinyl alcohol (PVA) or similar) and can lead to reduction in weight-specific surface area of the extrudate when compared with the powder form of the metal-organic frameworks. Also, hydrocolloids such as agars, starches, celluloses, xanthan, gelatins, casin, and the like with and without gelling agents have been used. Problems associated with these methods include pore blocking and a general lack of optimization with respect to shape, surface area and sphere strength. Further, thermal stability of the bio-polymer can limit the thermal stability of the materials produced. Recently, a method of using hydrocolloids was developed to produce spheres of metal-organic frameworks. Spjelkavik, A. I. et al., Forming MOFs into Spheres by Use of Molecular Gastronomy Methods, Chem. Pub. Soc. Eur., 20, 8973-8978, 2014. The methodology forms spheres containing more than 95 wt. % metal-organic frameworks having a maximum crush strength of under 7.0 lb. force.

### SUMMARY OF THE INVENTION

Provided herein are methods of making the present metal-organic framework spheres. In the present methods, sodium alginate and water are mixed to produce an aqueous sodium alginate solution. Metal-organic frameworks are added to the aqueous sodium alginate solution to produce an aqueous metal-organic framework alginate mixture. The metal-organic framework alginate mixture is added to a calcium chloride solution to form the metal-organic framework sphere. The calcium chloride solution comprises of water and calcium chloride. The metal-organic framework sphere has a crush strength of at least 10 lb. force and a surface area of at least 500 m²/g.

In addition, methods of making a metal-organic framework sphere are described herein comprising the steps of mixing at least 5.0 wt. % sodium alginate with water to produce an aqueous sodium alginate solution and adding a plurality of metal-organic frameworks to the aqueous sodium alginate solution to produce an aqueous metal-organic framework alginate mixture. The aqueous metal-organic framework alginate mixtures are added to an aqueous calcium chloride solution comprising between about 2.0 wt. % and 5.0 wt. % calcium chloride to form the metal-organic framework sphere having a crush strength of at least 10 lb. force, a surface area of at least 500 m²/g and greater than or equal to about 60 wt. % metal-organic frameworks.

Also, provided herein are compositions comprising a plurality of metal-organic frameworks positioned within a network of calcium alginate complexes, prepared by combining an aqueous metal-organic framework alginate mixture with an aqueous solution of calcium chloride wherein the aqueous metal-organic framework alginate mixture comprises less than about 20.0 wt. %. metal-organic frameworks, between about 1.0 wt. % and about 5.0 wt. % calcium chloride, and less than or equal to about 5.0 wt. % sodium alginate. Each of the metal-organic frameworks comprises at least one metal ion and at least one organic ligand. The composition comprises less than or equal to 70 wt. % metal-organic frameworks and has a crush strength of at least about 10 lb. force and a surface area of at least about 500 m²/g.

Presented herein are metal-organic framework spheres comprising between about 60 wt. % and about 70 wt. % metal-organic frameworks. Each of the metal organic frameworks comprises an organic ligand and a metal. The metal-organic frameworks are blended within a network of calcium alginate complexes. Each complex having alginate ionically crosslinked with calcium. The metal-organic framework sphere comprises at least 3.0 wt. % calcium and has a bulk crush strength at least 10 lb. force and a surface area of at least 500 m²/gram.

These and other features and attributes of the disclosed methods and compositions and their advantageous applications and/or uses will be apparent from the detailed description which follows.

### BRIEF DESCRIPTION OF THE DRAWINGS

To assist those of ordinary skill in the relevant art in making and using the subject matter hereof, reference is made to the appended drawings, wherein:

FIG. 1A is a graph showing N₂ isotherms taken at 77 K of Mg-MOF-74 with and without alginate sphere formation and FIG. 1B is a graph showing N₂ isotherms taken at 77 K of UiO-66 with and without alginate sphere formation.

FIG. 2 is a graph showing CO₂ isobars of mmen-Mg-MOF-274, mmen-Mg-MOF-274 spheronized using sodium alginate, and mmen-Mg-MOF-274 spheronized using sodium alginate following by re-amination using mmen or mmen/toluene.

FIG. 3 is a graph showing CO₂ isobars of mmen-Mg-MOF-274 spheronized using sodium alginate using both external and internal methods, sodium alginate spheres by themselves.

FIG. 4 shows the structure of sodium alginate before ionic cross-linking.

FIG. 5 shows the hypothesized structure of sodium alginate after ionic cross-linking using Ca²⁺.

### DETAILED DESCRIPTION

Before the present methods and devices are disclosed and described, it is to be understood that unless otherwise indicated this invention is not limited to specific compounds, components, compositions, reactants, reaction conditions, ligands, catalyst structures, metallocene structures, or the like, as such may vary, unless otherwise specified. It is also to be understood that the terminology used herein is for the purpose of describing particular embodiments only and is not intended to be limiting.

All numerical values within the detailed description and the claims herein are modified by “about” or “approximately” with respect to the indicated value, and take into account experimental error and variations that would be expected by a person having ordinary skill in the art. Unless otherwise indicated, room temperature is about 25° C.

For the sake of brevity, only certain ranges are explicitly disclosed herein. However, ranges from any lower limit can be combined with any upper limit to recite a range not explicitly recited, as well as, ranges from any lower limit can be combined with any other lower limit to recite a range not explicitly recited, in the same way, ranges from any upper limit can be combined with any other upper limit to recite a range not explicitly recited. Additionally, within a range includes every point or individual value between its end points even though not explicitly recited. Thus, every point or individual value can serve as its own lower or upper limit combined with any other point or individual value or any other lower or upper limit, to recite a range not explicitly recited.

For the purposes of this disclosure, the following definitions will apply:

As used herein, the terms “a” and “the” as used herein are understood to encompass the plural as well as the singular.

The term “aryl” means, unless otherwise stated, a polyunsaturated, aromatic substituent that can be a single ring or multiple rings fused together or linked covalently. In an aspect, the substituent has from 1 to 11 rings, or more specifically, 1 to 3 rings. The term “heteroaryl” refers to aryl substituent groups (or rings) that contain from one to four heteroatoms selected from N, O and S, wherein the nitrogen and sulfur atoms are optionally oxidized, and the nitrogen atom(s) are optionally quaternized. An exemplary heteroaryl group is a six-membered azine, e.g., pyridinyl, diazinyl and triazinyl. A heteroaryl group can be attached to the remainder of the molecule through a heteroatom. Non-limiting examples of aryl and heteroaryl groups include phenyl, 1-naphthyl, 2-naphthyl, 4-biphenyl, 1-pyrrolyl, 2-pyrrolyl, 3-pyrrolyl, 3-pyrazolyl, 2-imidazolyl, 4-imidazolyl, pyrazinyl, 2-oxazolyl, 4-oxazolyl, 2-phenyl-4-oxazolyl, 5-oxazolyl, 3-isoxazolyl, 4-isoxazolyl, 5-isoxazolyl, 2-thiazolyl, 4-thiazolyl, 5-thiazolyl, 2-furyl, 3-furyl, 2-thienyl, 3-thienyl, 2-pyridyl, 3-pyridyl, 4-pyridyl, 2-pyrimidyl, 4-pyrimidyl, 5-benzothiazolyl, purinyl, 2-benzimidazolyl, 5-indolyl, 1-isoquinolyl, 5-isoquinolyl, 2-quinoxalinyl, 5-quinoxalinyl, 3-quinolyl, and 6-quinolyl. Substituents for each of the above noted aryl and heteroaryl ring systems are selected from the group of acceptable substituents described below.

As used herein, the terms “alkyl,” “aryl,” and “heteroaryl” can optionally include both substituted and unsubstituted forms of the indicated species. Substituents for the aryl and heteroaryl groups are generically referred to as “aryl group substituents.” The substituents are selected from, for example: groups attached to the heteroaryl or heteroarene nucleus through carbon or a heteroatom (e.g., P, N, O, S, Si, or B) including, without limitation, substituted or unsubstituted alkyl, substituted or unsubstituted aryl, substituted or unsubstituted heteroaryl, substituted or unsubstituted heterocycloalkyl, —OR′, ═O, ═NR′, ═N—OR′, —NR′R″, —SR′, -halogen, —SiR′R″R″′, —OC(O)R′, —C(O)R′, —CO₂R′, —CONR′R″, —OC(O)NR′R″, —NR″C(O)R′, —NR′—C(O)NR″R″′, —NR″C(O)₂R′, —NR—C(NR′R″R″′)═NR″″, —NR—C(NR′R″)═NR″′, —S(O)R′, —S(O)R′, —S(O)NR′R″, —NRSOR′, —CN and, —R′, —, —CH(Ph), fluoro(C₁-C₄)alkoxy, and fluoro(C₁-C₄)alkyl, in a number ranging from zero to the total number of open valences on the aromatic ring system. Each of the above-named groups is attached to the aryl or heteroaryl nucleus directly or through a heteroatom (e.g., P, N, O, S, Si, or B); and where R′, R″, R″′ and R″″ are preferably independently selected from hydrogen, substituted or unsubstituted alkyl, substituted or unsubstituted heteroalkyl, substituted or unsubstituted aryl and substituted or unsubstituted heteroaryl. When a compound of the invention includes more than one R group, for example, each of the R groups is independently selected as are each R′, R″, R″′ and R″″ groups when more than one of these groups is present.

The term “alkyl,” by itself or as part of another substituent, means, unless otherwise stated, a straight or branched chain, or cyclic hydrocarbon radical, or combination thereof, which may be fully saturated, mono- or polyunsaturated and can include di-, tri- and multivalent radicals, having the number of carbon atoms designated (i.e. C₁-C₁₀ means one to ten carbons). Examples of saturated hydrocarbon radicals include, but are not limited to, groups such as methyl, ethyl, n-propyl, isopropyl, n-butyl, t-butyl, isobutyl, sec-butyl, cyclohexyl, (cyclohexyl)methyl, cyclopropylmethyl, homologs and isomers of, for example, n-pentyl, n-hexyl, n-heptyl, n-octyl, and the like. An unsaturated alkyl group is one having one or more double bonds or triple bonds. Examples of unsaturated alkyl groups include, but are not limited to, vinyl, 2-propenyl, crotyl, 2-isopentenyl, 2-(butadienyl), 2,4-pentadienyl, 3-(1,4-pentadienyl), ethynyl, 1- and 3-propynyl, 3-butynyl, and the higher homologs and isomers. The term “alkyl,” unless otherwise noted, is also meant to optionally include those derivatives of alkyl defined in more detail below, such as “heteroalkyl.”

The terms “halo” or “halogen,” by themselves or as part of another substituent, mean, unless otherwise stated, a fluorine, chlorine, bromine, or iodine atom.

As used herein, an “isotherm” refers to the adsorption of an adsorbate as function of concentration while the temperature of the system is held constant. In an embodiment, the adsorbate is CO₂ and concentration can be measured as CO₂ pressure. As described herein, isotherms can be performed with porous materials and using various mathematical models applied to calculate the apparent surface area. Brunauer, S., et al., Adsorption of Gases in Multimolecular Layers, J. Am. Chem. Soc., 60, 309-319, 1938; Walton, K. S., et al., Applicability of the BET Method for Determining Surface Areas of Microporous Metal-Organic Frameworks, J. Am. Chem. Soc., 129, 27, 8552-8556, 2007; Langmuir, I., The Constitution and Fundamental Properties of Solids and Liquids. Part I. Solids, J. Am. Chem. Soc., 38, 11, 2221-2295, 1916.

As used herein, the term “ligand” means a molecule containing one or more substituent groups capable of functioning as a Lewis base (electron donor). In an aspect, the ligand can be oxygen, phosphorus or sulfur. In an aspect, the ligand can be an amine or amines containing 1 to 10 amine groups.

The symbol “R” is a general abbreviation that represents a substituent group that is selected from H, substituted or unsubstituted alkyl, substituted or unsubstituted heteroalkyl, substituted or unsubstituted aryl, substituted or unsubstituted heteroaryl, and substituted or unsubstituted heterocycloalkyl groups.

As used herein, the term “Periodic Table” means the Periodic Table of the Elements of the International Union of Pure and Applied Chemistry (IUPAC), dated December 2015.

The term “salt(s)” includes salts of the compounds prepared by the neutralization of acids or bases, depending on the particular ligands or substituents found on the compounds described herein. When compounds of the present invention contain relatively acidic functionalities, base addition salts can be obtained by contacting the neutral form of such compounds with a sufficient amount of the desired base, either neat or in a suitable inert solvent. Examples of base addition salts include sodium, potassium, calcium, ammonium, organic amino, or magnesium salt, or a similar salt. Examples of acid addition salts include those derived from inorganic acids like hydrochloric, hydrobromic, nitric, carbonic, monohydrogencarbonic, phosphoric, monohydrogenphosphoric, dihydrogenphosphoric, sulfuric, monohydrogensulfuric, hydriodic, or phosphorous acids, and the like, as well as the salts derived from relatively nontoxic organic acids like acetic, propionic, isobutyric, butyric, maleic, malic, malonic, benzoic, succinic, suberic, fumaric, lactic, mandelic, phthalic, benzenesulfonic, p-tolylsulfonic, citric, tartaric, methanesulfonic, and the like. Certain specific compounds of the present disclosure contain both basic and acidic functionalities that allow the compounds to be converted into either base or acid addition salts. Hydrates of the salts are also included.

It is understood that, in any compound described herein having one or more chiral centers, if an absolute stereochemistry is not expressly indicated, then each center may independently be of R-configuration or S-configuration or a mixture thereof. Thus, the compounds provided herein may be enantiomerically pure or be stereoisomeric mixtures. In addition, it is understood that, in any compound described herein having one or more double bond(s) generating geometrical isomers that can be defined as E or Z, each double bond may independently be E or Z or a mixture thereof. Likewise, it is understood that, in any compound described, all tautomeric forms are also intended to be included.

In addition, the compounds provided herein may also contain unnatural proportions of atomic isotopes at one or more of the atoms that constitute such compounds. For example, the compounds may be radiolabeled with radioactive isotopes, such as for example tritium (³H), iodine-125 (¹²⁵I) or carbon-14 (¹⁴C). All isotopic variations of the subject compounds, whether radioactive or not, are intended to be encompassed within the scope of present disclosure.

As used herein, the terms, “metal organic-framework material” or “MOF material” refer to a metal or metalloid and an organic ligand capable of coordination with the metal or metalloid. Metal-organic framework coordination networks of organic ligands and metals (or metalloids) can form porous three-dimensional structures.

As used herein, a “metal organic framework” can be a mixed-metal organic framework or a metal-organic framework system or a mixed-metal mixed-organic framework system as described in PCT Published Patent Application, WO2020/219907.

Generally, metal-organic frameworks (“MOFs”) are a class of highly porous materials with potential applications in a wide range of fields including gas storage, gas and liquid separations, isomer separation, sensing, environmental remediation, waste removal, and catalysis, among others. In contrast to zeolites, which are purely inorganic in character, MOFs utilize organic ligands which can function as “struts” bridging metal atoms or clusters of metal atoms together. Like zeolites, MOFs are microporous. The pore shape and size of the metal-organic framework (“MOF”) can be tuned through selection of the organic ligands and metals. Because organic ligands can be modified, MOFs as a whole are structurally diverse which is different than zeolites. Factors that influence the structure of MOFs include, for example, one or more of ligand denticity, size and type of the coordinating group(s), additional substitution remote or proximate to the coordinating groups, ligand size and geometry, ligand hydrophobicity or hydrophilicity, choice of metal and/or metal salt, choice of solvent, and reaction conditions such as temperature, concentration, and the like.

Metal-organic frameworks are materials comprised of both metals and multi-topic organic linkers that self-assemble to form a coordination network. In actual application, the strength and shape of the material is crucial for performance. Shaped particles help avoid large pressure drops in adsorbent beds and allow for easier material handling. Therefore, powder MOFs are often shaped into extrudates, rings, pellets, spheres, etc. In addition to maintaining the chemical and physical properties of the shaped material, mechanical strength is also of critical importance. MOFs as a powder have poor mechanical properties (i.e., zero crush strength).

MOFs are currently synthesized or obtained commercially as crystalline powder materials. Powder materials are often shaped into extrudates, rings, pellets, spheres, etc. In addition to maintaining the chemical and physical properties of the shaped material, mechanical strength is also of critical importance. MOFs alone have poor mechanical properties (i.e., zero crush strength).

As described above, for many industrial and commercial products, powder-form MOFs can be shaped into larger, coherent bodies having a defined shape that can be desirable. Conventional methods of consolidating powder-form MOFs into large bodies, such as pelletizing and extrusion, often afford less than desirable physical and mechanical properties. More specifically, processing of powder-form MOFs through compaction can result in surface areas which are lower than the powder-form of MOFs due to pressure sensitivity of the metal-organic framework (“MOF”) structure and relatively low crush strength. Further, certain processing conditions can lead to full or partial phase transformation of the initial MOF structure, as evidenced by X-ray powder diffraction and surface area analyses. Each of these factors can be problematic for producing MOFs in the form of shaped bodies and/or using the shaped bodies as a device in various applications.

While it is desirable to consolidate a metal-organic framework powder into a more coherent (shaped) body, the properties of MOFs, specifically their weakness against pressure and shear, can lead to various issues under pressures (e.g., about 100 psi to several thousand psi) and shear used to consolidate powder-form MOFs, particularly during extrusion. Such processing of the MOF powder can collapse at least a portion of the pores within the MOF structure and lead to an undesirable and oftentimes significant decrease in BET surface area. Moreover, conditions used for consolidating powder-form MOFs into a shaped body can lead to at least partial and sometimes full conversion of the MOF structure into another material, such as another crystalline phase. Consolidated MOFs having poor crush strength can be problematic. For example, poor crush strength values can lead to production of fines, which may be detrimental to certain applications, in addition to problems with shipping.

### Metal-Organic Frameworks

As provided herein, a metal-organic framework can be ZIFs (or Zeolitic Imidazolate Frameworks), MILs (or Matériaux de l'Institut Lavoisier), and IRMOFs (or IsoReticular Metal Organic Frameworks), alone or combination with other MOFs. In certain embodiments, the MOF is selected from: HKUST-1, MOF-74, MIL-100, ZIF-7, ZIF-8, ZIF-90, UiO-66, UiO-67, MOF-808 or MOF-274. In an aspect, the metal-organic framework is selected from the group of HKUST-1, UiO-66, ZIF-8, ZIF-7, MIL-100, MOF-74, M₂(m-dobdc), MOF-274, Cu(Qc)₂ and combination(s) thereof.

MOFs can be prepared via combination of an organic ligand, or one or a combination of two or more organic ligands, and a metal or metalloid as described below. For example, MOF-274 and EMM-67 are a combination of Mg²⁺, Mn²⁺, Fe²⁺, Zn²⁺, Ni²⁺, Cu²⁺, Co²⁺ or combinations thereof with 4,4′-dihydroxy-(1,1′-biphenyl)-3,3′-dicarboxylic acid. See, WO 2020/219907. Additionally, MOF-274 can include amines coordinated to the metal sites within its structure.

### Organic Ligands

As used herein, an organic ligand is a ligand that is monodentate, bidentate, or multi-dentate. The organic ligand can be a single type of ligand, or combination(s) thereof. Generally, the organic ligand is capable of coordination with the metal ion, in principle all compounds can be used which are suitable for such coordination. Organic ligands including at least two centers, which are capable to coordinate the metal ions of a metal salt, or metals or metalloids. In an aspect, an organic ligand includes: i) an alkyl group substructure, having from 1 to 10 carbon atoms, ii) an aryl group substructure, having from 1 to 5 aromatic rings, iii) an alkyl or aryl amine substructure, consisting of alkyl groups having from 1 to 10 carbon atoms or aryl groups having from 1 to 5 aromatic rings, where the substructures have at least two functional groups “X”, which are covalently bound to the substructure, and where X is capable of coordinating to a metal or metalloid.

In an aspect, each X is independently selected from neutral or ionic forms of CO₂H, OH, SH, NH₂, CN, HCO, CS₂H, NO₂, SO₃H, Si(OH)₃, Ge(OH)₃, Sn(OH)₃, Sn(SH)₃, PO₃H, CH(RSH)₂, C(RSH)₃, CH(RNH₂)₂, C(RNH₂)₃, CH(ROH)₂, C(ROH)₃, CH(RCN)₂, C(RCN)₃, CH(SH)₂, C(SH)₃, CH(NH₂)₂, C(NH₂)₂, CH(OH)₂, C(OH)₃, CH(CN)₂, C(CN)₃, nitrogen-containing heterocycles, sulfur-containing heterocycles, and combination(s) thereof, where R is an alkyl group having from 1 to 5 carbon atoms, or an aryl group consisting of 1 to 2 phenyl rings.

In an aspect, the organic ligand includes substituted or unsubstituted, mono- or polynuclear aromatic di-, tri- and tetracarboxylic acids and substituted or unsubstituted, at least one hetero atom including aromatic di-, tri- and tetracarboxylic acids, which have one or more nuclei.

In an aspect, the organic ligand is benzenetricarboxylate (BTC) (one or more isomers), ADC (acetylene dicarboxylate), NDC (naphtalenedicarboxylate) (any isomer), BDC (benzene dicarboxylate) (any isomer), ATC (adamantanetetracarboxylate) (any isomer), BTB (benzenetribenzoate) (any isomer), MTB (methane tetrabenzoate), ATB (adamantanetribenzoate) (any isomer), biphenyl-4,4′-dicarboxylate, benzene-1,3,5-tris(1H-tetrazole), imidazole, or derivatives thereof, or combination(s) thereof.

Ligands which possess multidentate functional groups can include corresponding counter cations, such as H⁺, Na⁺, K⁺, Mg²⁺, Ca²⁺, Sr²⁺, ammonium ion, alkylsubstituted ammonium ions, and arylsubstituted ammonium ions, or counteranions, such as F⁻, Cl⁻, Br⁻, I⁻, ClO⁻, ClO₂⁻, ClO₃⁻, ClO₄⁻, OH⁻, NO₃⁻, NO₂⁻, SO₄²⁻, SO₃²⁻, PO₄³⁻, CO₃²⁻, and HCO³⁻.

In an aspect, the organic ligands include monodentate functional groups. A monodentate functional group is defined as a moiety bound to a substructure, which can include an organic ligand or amine ligand substructure, L, as defined previously, which can form only one bond to a metal ion. According to this definition, a ligand can contain one or more monodentate functional groups. For example, cyclohexylamine and 4,4′-bipyridine are ligands that contain monodentate functional groups, since each functional group is capable of binding to only one metal ion.

Accordingly, cyclohexylamine is a monofunctional ligand containing a monodentate functional group and 4,4′-bipyridine is a bifunctional ligand containing two monodentate functional groups. Specific examples of ligands containing monodentate functional groups are pyridine, which is a monofunctional ligand, hydroquinone, which is a difunctional ligand, and 1,3,5-tricyanobenzene, which is a trifunctional ligand.

Ligands having monodentate functional groups can be blended with ligands that contain multidentate functional groups to make an MOF in the presence of a suitable metal ion and optionally a templating agent. Monodentate ligands can also be used as templating agents. Templating agents can be added to the reaction mixture for the purpose of occupying the pores in the resulting MOF. Monodentate ligands and/or templating agents can include the following substances and/or derivatives thereof.

A. Alkyl or aryl amines or phosphines and their corresponding ammonium or phosphonium salts, the alkyl amines or phosphines can include linear, branched, or cyclic aliphatic groups, having from 1 to 20 carbon atoms (and their corresponding ammonium salts), the aryl amines or phosphines can include 1 to 5 aromatic rings including heterocycles. Examples of monofunctional amines are methylamine, ethylamine, n-propylamine, iso-propylamine, n-butylamine, sec-butylamine, iso-butylamine, tert-butylamine, n-pentylamine, neo-pentylamine, n-hexylamine, pyrrolidine, 3-pyrroline, piperidine, cyclohexylamine, morpholine, pyridine, pyrrole, aniline, quinoline, isoquinoline, 1-azaphenanthrene, and 8-azaphenanthrene. Examples of difunctional and trifunctional amines are 1,4-diaminocyclohexane, 1,4-diaminobenzene, 4,4′-bipyridyl, imidazole, pyrazine, 1,3,5-triaminocyclohexane, 1,3,5-triazine, and 1,3,5-triaminobenzene.

B. Alcohols that contain alkyl or cycloalkyl groups, containing from 1 to 20 carbon atoms, or aryl groups, containing from 1 to 5 phenyl rings. Examples of monofunctional alcohols are methanol, ethanol, n-propanol, iso-propanol, allyl alcohol, n-butanol, iso-butanol, sec-butanol, tert-butanol, n-pentanol, iso-pentanol, sec-pentanol, neo-pentanol, n-hexanol, cyclohexanol, phenol, benzyl alcohol, and 2-phenylethanol. Examples of difunctional and trifunctional alcohols are 1,4-dihydroxycyclohexane, hydroquinone, catechol, resorcinol, 1,3,5-trihydroxybenzene, and 1,3,5-trihydroxycyclohexane.

C. Ethers that contain alkyl or cycloalkyl groups, containing from 1 to 20 carbon atoms, or aryl groups, containing from 1 to 5 phenyl rings. Examples of ethers are diethyl ether, furan, and morpholine.

D. Thiols that contain alkyl or cycloalkyl groups, containing from 1 to 20 carbon atoms, or aryl groups, containing from 1 to 5 phenyl rings. Examples of monofunctional thiols are thiomethane, thioethane, thiopropane, thiocyclohexane, thiophene, benzothiophene, and thiobenzene. Examples of difunctional and trifunctional thiols are 1,4-dithiocyclohexane, 1,4-dithiobertzene, 1,3,5-trithiocyclohexane, and 1,3,5-trithiobenzene.

E. Nitriles that contain alkyl or cycloalkyl groups, containing from 1 to 20 carbon atoms, or aryl groups, containing from 1 to 5 phenyl rings. Examples of monofunctional nitriles are acetonitrile, propanenitrile, butanenitrile, n-valeronitrile, benzonitrile, and p-tolunitrile. Examples of difunctional and trifunctional nitriles are 1,4-dinitrilocyclohexane, 1,4-dinitrilobenzene, 1,3,5-trinitrilocyclohexane, and 1,3,5-trinitrilobenzene.

F. Inorganic anions from the group consisting of: sulfate, nitrate, nitrite, sulfite, bisulfite, phosphate, hydrogen phosphate, dihydrogen phosphate, diphosphate, triphosphate, phosphite, chloride, chlorate, bromide, bromate, iodide, iodate, carbonate, bicarbonate, thiocyanide and isonitrile, and the corresponding acids and salts of the aforementioned inorganic anions.

G. Organic acids and the corresponding anions (and salts). The organic acids can include alkyl organic acids containing linear, branched, or cyclic aliphatic groups, having from 1 to 20 carbon atoms, or aryl organic acids and their corresponding aryl organic anions and salts, having from 1 to 5 aromatic rings which can include heterocycles.

H. Other organic and inorganics such as ammonia, carbon dioxide, methane, oxygen, ethylene, hexane, benzene, toluene, xylene, chlorobenzene, nitrobenzene, naphthalene, thiophene, pyridine, acetone, 1-2-dichloroethane, methylenechloride, tetrahydrofuran, ethanolamine, triethylamine or trifluoromethylsulfonic acid.

Additionally, templating agents can include other aliphatic and aromatic hydrocarbons not containing functional groups. In an aspect, templating agents include cycloalkanes, such as cyclohexane, adamantane, or norbornene, and/or aromatics, such as benzene, toluene, or xylenes.

### Metal Ions

As described above, the metal-organic framework can be synthesized by combining metal ions, organic ligands, and optionally a suitable templating agent. Suitable metal ions include metals and metalloids of varying coordination geometries and oxidation states. In an aspect, metal-organic frameworks are produced using metal ions having distinctly different coordination geometries, in combination with a ligand possessing multidentate functional groups, and a suitable templating agent. Metal-organic frameworks can be prepared using a metal ion that prefers octahedral coordination, such as cobalt (II), and/or a metal ion that prefers tetrahedral coordination, such as zinc (II). MOFs can be made using one or more of the following metal ions: Mg²⁺, Ca²⁺, Sr²⁺, Ba²⁺, Sc³⁺, Y³⁺, Ti⁴⁺, Zr⁴⁺, Hf⁴⁺, V⁵⁺, V⁴⁺, V³⁺, V²⁺, Nb³⁺, Ta³⁺, Cr³⁺, Mo³⁺, W³⁺, Mn³⁺, Mn²⁺, Re³⁺, Re²⁺, Fe³⁺, Fe²⁺, Ru³⁺, Ru²⁺, Os³⁺, Os²⁺, Co³⁺, Co²⁺, Rh²⁺, Rh⁺, Ir²⁺, Ir⁺, Pd²⁺, Pd⁺, Pt²⁺, Pt⁺, Cu²⁺, Cu⁺, Ag⁺, Au⁺, Zn²⁺, Cd²⁺, Hg²⁺, Al³⁺, Ga³⁺, In³⁺, Tl³⁺, Si⁴⁺, Si²⁺, Ge⁴⁺, Ge²⁺, Sn⁴⁺, Sn²⁺, Pb⁴⁺, Pb²⁺, As⁵⁺, As³⁺, As⁺, Sb⁵⁺, Sb³⁺, Sb⁺, and Bi⁵⁺, Bi³⁺, Bi⁺, Be²⁺; along with the corresponding metal salt counterion. The term metal ion refers to both metal and metalloid ions. In an aspect, suitable metal ions include: Sc³⁺, Ti⁴⁺, V⁴⁺, V³⁺, V²⁺, Cr³⁺, Mo³⁺, Mg²⁺, Mn³⁺, Mn²⁺, Fe³⁺, Fe²⁺, Ru³⁺, Ru²⁺, Os³⁺, Os²⁺, Co³⁺, Co²⁺, Rh²⁺, Rh⁺, Ir²⁺, Ir⁺, Ni²⁺, Pd⁺, Pt²⁺, Pt⁺, Cu²⁺, Cu⁺, Ag⁺, Au⁺, Zn²⁺, Cd²⁺, Al³⁺, Ga³⁺, In³⁺, Ge⁴⁺, Ge²⁺, Sn⁴⁺, Sn²⁺, Pb⁴⁺, Pb²⁺, Sb⁵, Sb³⁺, Sb⁺, and/or Bi⁵⁺, Bi³⁺, Bi⁺, Be²⁺; along with the corresponding metal salt counteranion. In an aspect, metal ions include: Sc³⁺, Ti⁴⁺, V⁴⁺, V³⁺, Cr³⁺, Mo³⁺, Mn³⁺, Mn²⁺, Fe³⁺, Fe²⁺, Co³⁺, Co²⁺, Cu²⁺, Cu⁺, Ag⁺, Zn²⁺, Cd²⁺, Al³⁺, Sn⁴⁺, Sn²⁺, and/or Bi⁵⁺, Bi³⁺, Bi⁺; along with the corresponding metal salt counterion. In an aspect, the metal ions for use in production of MOFs are selected from the group consisting of: Mg²⁺, Mn³⁺, Mn²⁺, Fe³⁺, Fe²⁺, Co³⁺, Co²⁺, Cu²⁺, Cu⁺, Pt²⁺, Ag⁺, and Zn²⁺, along with the corresponding metal salt counterion.

### Preparation of Metal-Organic Frameworks

The synthesis of a rigid and stable metal-organic framework (“MOF”) can be carried out under mild reaction conditions. In most cases, the reagents are combined into a solution, either aqueous or nonaqueous, with synthetic reaction temperatures ranging from 0° C. to 100° C. (in an open beaker). In other cases, solution reactions are carried out in a closed vessel at temperatures from 25° C. to 300° C. In either case, large single crystals or microcrystalline microporous solids are formed.

In preparing the MOF, reactants can be added in a mole ratio of 1:10 to 10:1 metal ion to ligand containing multidentate functional groups. In an aspect, the ratio of the metal ion to ligand containing multidentate functional groups is 1:3 to 3:1, such as from 1:2 to 2:1. A templating agent can in certain circumstances be employed as the solvent in which the reaction takes place. The amount of templating agent can affect the production of MOF. Templating agents can accordingly be employed in excess without interfering with the reactions and the preparation of the MOF. Additionally, when using a ligand containing monodentate functional groups in combination with the metal ion and the ligand containing multidentate functional groups, the ligand containing monodentate functional groups can added in excess. In certain circumstances the ligand containing monodentate functional groups can be utilized as the solvent in which the reaction takes place. In addition, in certain circumstances the templating agent and the ligand containing monodentate functional groups can be identical. An example of a templating agent which is a ligand containing monodentate functional groups is pyridine.

The MOF synthesis can be carried out in either an aqueous system or non-aqueous system. As used herein, an aqueous system or a non-aqueous system means and includes the states of in solution or in suspension. The solvent can be polar or nonpolar, and the solvent can be a templating agent, or the optional ligand containing a monodentate functional group. Examples of non-aqueous solvents include n-alkanes, such as pentane, hexane, benzene, toluene, xylene, chlorobenzene, nitrobenzene, cyanobenzene, aniline, naphthalene, naphthas, n-alcohols such as methanol, ethanol, n-propanol, isopropanol, acetone, 1,2-dichloroethane, methylene chloride, chloroform, carbon tetrachloride, tetrahydrofuran, dimethylformamide, dimethylsulfoxide, thiophene, pyridine, ethanolamine, triethylamine, ethylenediamine, and the like.

To form large single crystals of microporous materials, suitable for single crystal x-ray structural characterization, the solution reaction can be performed in the presence of viscous materials, such as polymeric additives. Specific additives can include polyethylene oxide, polymethylmethacrylic acid, silica gels, agar, fats, and collagens, which can aid in achieving high yields and pure crystalline products. The growth of large single crystals of microporous materials leads to unambiguous characterization of the microporous framework. Large single crystals of microporous materials can be useful for magnetic and electronic sensing applications.

### Optional Additives

A metal-organic framework can comprise additives such as fillers, antioxidants (e.g., hindered phenolics such as IRGANOX™ 1010 or IRGANOX™ 1076 available from Ciba-Geigy), inhibitors of photo-oxidation (e.g., hindered amine light stabilizers, HALS, such as TINUVN® 123 available from BASF, phosphites (e.g., IRGAFOS™ 168 available from Ciba-Geigy), anti-cling additives, tackifiers, such as polybutenes, terpene resins, aliphatic and aromatic hydrocarbon resins, alkali metal and glycerol stearates, and hydrogenated rosins, UV stabilizers; heat stabilizers, anti-blocking agents, release agents, anti-static agents, pigments; colorants, dyes, waxes, silica, fillers, and talc.

Other optional additives include silica, such as precipitated silica and silica originating from by-products such as fly-ash, for example silica-alumina, silica-calcium particles, or fumed silica. In an aspect, the silica is particulate matter and has an average particle size of 10 μm or less, such as 5 μm or less, or 1 μm or less. In an aspect, the silica is amorphous silica.

Other additives that can be optionally included in the metal-organic coating layer include inorganic compounds, such as titanium dioxide, hydrated titanium dioxide, hydrated alumina or alumina derivatives, mixtures of silicon and aluminum compounds, silicon compounds, clay minerals, alkoxysilanes, and amphiphilic substances. Additives can also include any suitable compound use for adhesion of powdery materials, such as oxides, of silicon, of aluminum, of boron, of phosphorus, of zirconium and/or of titanium. Additionally, additives can include oxides of magnesium and of beryllium. Furthermore, tetraalkoxysilanes can be used as additives, such as tetramethoxysilane, tetraethoxysilane, tetrapropoxysilane and tetrabutoxysilane, the analogous tetraalkoxytitanium and tetraalkoxyzirconium compounds and trimethoxy-, triethoxy-, tripropoxy- and tributoxy-aluminum.

### Use of Sodium Alginate and Calcium Chloride Solutions

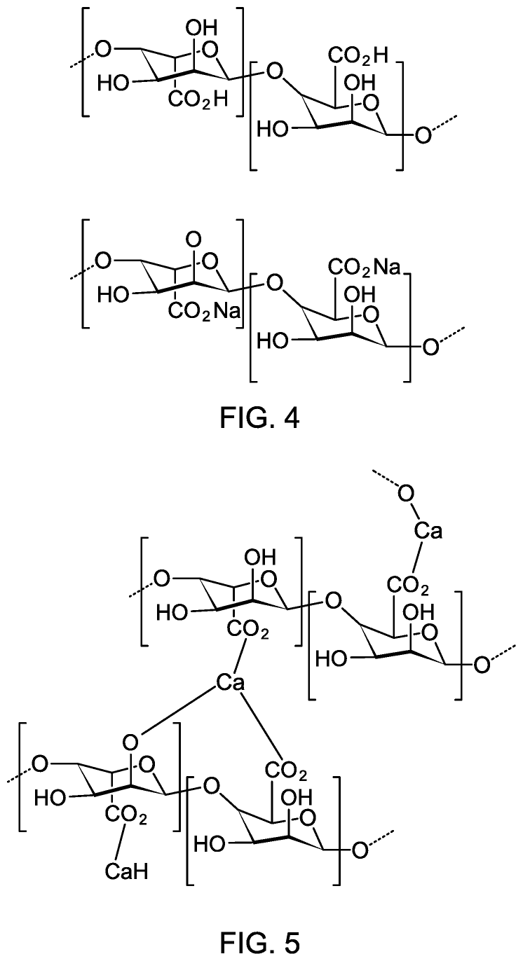

Sodium alginate is the sodium salt of alginic acid and a hydrophilic polysaccharide found inside the cell walls of brown algae. FIG. 4. Alginic acid is a linear copolymer with homopolymeric blocks of (1→4)-linked 1-D-mannuronate (M) and α-L-guluronate (G) residues, respectively, covalently linked together in different sequences or blocks. The monomers may appear in homopolymeric blocks of consecutive G-residues (G-blocks), consecutive M-residues (M-blocks) or alternating M and G-residues (MG-blocks). Note that α-L-guluronate is the C-5 epimer of β-D-mannuronate. Calcium alginate is made from sodium alginate from which two sodium ions have been removed and replaced with one calcium ion.

Sodium alginate forms solutions in water. With increasing concentration and molecular weight of sodium alginate, the viscosity of the solution increases. When aqueous solutions of sodium alginate are mixed with aqueous solutions of multivalent, predominately divalent, cations (e.g., Ca²⁺, Ba²⁺), ionic cross-linking occurs, resulting in the formation of a gel materials FIG. 5.

As presented herein, aqueous sodium alginate solutions can be formulated with metal-organic framework powders, which in turn, can be added to calcium chloride aqueous solutions to produce metal-organic framework spheres. The metal-organic framework spheres can then be used similar to an extruded or granulated formed material.

### Present Methods of Forming Metal-Organic Framework Spheres

Provided herein are methods of making the present metal-organic framework spheres. In the present methods, sodium alginate and water are mixed to produce an aqueous sodium alginate solution. Metal-organic frameworks are added to the aqueous sodium alginate solution to produce an aqueous metal-organic framework alginate mixture. The aqueous metal-organic framework alginate mixture includes waterborne metal-organic framework alginate mixtures where molecules are solvated in an aqueous medium. A calcium chloride solution comprising water and calcium chloride is also prepared. The metal-organic framework alginate mixture is added to the calcium chloride solution to form metal-organic framework spheres. As provided herein, the metal-organic framework sphere has a crush strength of at least 10 lb. force and a surface area of at least 500 m²/g.

More specifically, calcium chloride can be dissolved in water to produce the calcium chloride solution. Sodium alginate and water are mixed to produce an aqueous sodium alginate solution. Metal-organic frameworks are added to the aqueous sodium alginate solution to produce an aqueous metal-organic framework alginate mixture. The aqueous metal-organic framework alginate mixture is added to the calcium chloride solution to form the metal-organic framework sphere. In an aspect, at least 5.0 wt. % sodium alginate is mixed with water to produce an aqueous sodium alginate solution. In an aspect, the aqueous calcium chloride solution comprises between about 2.0 wt. % and 5.0 wt. % calcium chloride. In an aspect, a wet metal-organic framework sphere comprises at least 60 wt. % of metal-organic frameworks in a dried metal-organic framework sphere. As described herein, the metal-organic framework spheres produced with the present methods have a crush strength of at least 10 lb. force and a surface area of at least 500 m²/g.

In an aspect, the metal-organic framework spheres comprise between about 60 wt. % and about 70 wt. % metal-organic frameworks. In an aspect, the metal-organic framework sphere comprises at least 3.0 wt. % calcium. In an aspect, the calcium chloride solution comprises at least 3.0 wt. % calcium chloride. In an aspect, the aqueous sodium alginate solution has a temperature of between about 20° C. and about 25° C. In an aspect, the aqueous metal-organic framework alginate mixture is a slurry. In an aspect, the slurry comprises at least 10 wt. % of metal-organic framework. In an aspect, the slurry is added dropwise to the calcium chloride solution. Further, the metal-organic frameworks are blended within a network of calcium alginate bound by no theory. In an aspect, each complex has alginate ionically crosslinked with calcium. The methods produce a composition comprising about 70 wt. % or less metal-organic frameworks and a network of calcium alginate complexes combined with the metal-organic frameworks to form a metal-organic framework sphere having a bulk crush strength of at least about 10 lb. force.

Also provided herein are compositions comprising a plurality of metal-organic frameworks positioned within a network of calcium alginate complexes, prepared by combining an aqueous metal-organic framework alginate mixture with an aqueous solution of calcium chloride wherein the aqueous metal-organic framework alginate mixture comprises less than 5 wt. % alginate, and at least 10 wt. % of wet metal-organic framework. Each of the metal-organic frameworks comprises at least one metal ion and at least one organic ligand. The composition comprises less than or equal to 70 wt. % metal-organic frameworks and has a crush strength of at least about 10 lb. force and a surface area of at least about 500 m²/gram.

As described herein, each of the metal organic frameworks comprises an organic ligand and a metal. In an aspect, the organic ligand comprises one or more of: an alkyl group substructure having from 1 to 10 carbon atoms; or an aryl group substructure having from 1 to 5 aromatic rings. The one or more substructures each have at least two X groups, and wherein X is a functional group configured to coordinate to a metal or metalloid. In an aspect, the present methods can make a metal-organic framework comprises an organic ligand comprising an alkylamine substructure having from 1 to 10 carbon atoms or an arylamine or nitrogen-containing heterocycle substructure having from 1 to 5 aromatic rings; and wherein the substructure(s) each have at least two X groups, and wherein X is a functional group configured to coordinate to a metal or metalloid. In an aspect, in either instance, each X is independently selected from neutral or ionic forms of CO₂H, OH, SH, OH₂, NH₂, CN, HCO, CS₂H, NO₂, SO₃H, Si(OH)₃, Ge(OH)₃, Sn(OH)₃, Si(SH)₄, Ge(SH)₄, Sn(SH)₃, PO₃H, AsO₃H, AsO₄H, P(SH)₃, As(SH)₃, CH(RSH)₂, C(RSH)₃, CH(RNH₂)₂, C(RNH₂)₃, CH(ROH)₂, C(ROH)₃, CH(RCN)₂, C(RCN)₃, CH(SH)₂, C(SH)₃, CH(NH₂)₂, C(NH₂)₂, CH(OH)₂, C(OH)₃, CH(CN)₂, C(CN)₃, nitrogen-containing heterocycles, sulfur-containing heterocycles, or combination(s) thereof, wherein R is an alkyl group having from 1 to 5 carbon atoms or an aryl group of 1 to 2 phenyl rings. In an aspect, the organic ligand is 1,3,5-benzenetricarboxylate, 1,4-benzenedicarboxylate, 1,3-benzenedicarboxylate, biphenyl-4,4′-dicarboxylate, benzene-1,3,5-tris(1H-tetrazole), acetylene-1,2-dicarboxylate, naphtalenedicarboxylate, adamantanetetracarboxylate, benzenetribenzoate, methanetetrabenzoate, adamantanetribenzoate, biphenyl-4,4′-dicarboxylate, imidazole, 2,5-dihydroxy-1,4-benzendicarboxylic acid, 4,4′-dihydroxy-(1,1′-biphenyl)-3,3′-dicarboxylic acid derivatives thereof, or combination(s) thereof.

In addition, the present methods can make a metal-organic framework comprising a metal ion selected from Be²⁺, Mg²⁺, Ca²⁺, Sr²⁺, Ba²⁺, Sc³⁺, Y³⁺, Ti⁴⁺, Zr⁴⁺, Hf⁺, V⁴⁺, V³⁺, V²⁺, Nb³⁺, Ta³⁺, Cr³⁺, Mo³⁺, W³⁺, Mn³⁺, Mn²⁺, Re³⁺, Re²⁺, Fe³⁺, Fe²⁺, Ru³⁺, Ru²⁺, Os³⁺, Os²⁺, Co³⁺, Co²⁺, Rh²⁺, Rh⁺, Ir²⁺, Ir⁺, Pd²⁺, Pd⁺, Pt²⁺, Pt⁺, Cu²⁺, Cu⁺, Ag⁺, Au⁺, Zn²⁺, Cd²⁺, Hg²⁺, Al³⁺, Ga³⁺, In³⁺, Tl³⁺, Si⁴⁺, Si²⁺, Ge⁴⁺, Ge²⁺, Sn⁴⁺, Sn²⁺, Pb⁴⁺, Pb²⁺, As⁵⁺, As³⁺, As⁺, Sb⁵⁺, Sb³⁺, Sb⁺, and Bi⁵⁺, Bi³⁺, Bi⁺, or combination(s) thereof. In an aspect, the metal ion can be Mg²⁺, Mn³⁺, Mn²⁺, Fe³⁺, Fe²⁺, Co³⁺, Co²⁺, Cu²⁺, Cu⁺, Pt²⁺, Ag⁺, Zn²⁺, Zr⁴⁺, Hf⁴⁺, or combination(s) thereof.

In an aspect, the metal-organic framework sphere comprises the metal-organic frameworks, UiO-66 or Mg-MOF-74 or HKUST-1 or mmen-Mg-MOF-274. In an aspect, the metal-organic framework sphere produced by the present methods is capable of absorbing CO₂ in an energy efficient temperature swing adsorption process.

As shown in the Examples below, the combination of the aqueous metal-organic framework alginate mixture and calcium chloride can form a spherical composition with different metal-organic frameworks to provide metal-organic framework materials having increased crush strength (e.g., as measured by ASTM D4179-11 (2017)). These metal-organic framework spheres maintain high microporous surface area as measured by low temperature N₂ isotherms. The spheres are also capable of adsorbing CO₂ for applications in temperature swing adsorption processes.

As demonstrated, adding metal-organic framework materials directly into the calcium chloride solution resulted in a metal-organic framework sphere.

### EXAMPLES

The features of the invention are described in the following non-limiting examples.

### Example 1: Metal-Organic Framework Spheres Formation

A calcium chloride (CaCl₂)) aqueous solution was formed by dissolving calcium chloride in water at room temperature. A sodium alginate solution was formed by mixing sodium alginate and warm water and then allowing the solution to cool to room temperature. Metal-organic frameworks were then added to the sodium alginate solution, resulting in a slurry. The slurry comprising metal-organic frameworks and alginate was then added dropwise (from approximately 1 foot in the air) to the CaCl₂ solution as it was stirred. This resulted in the formation of spherical or near-spherical macroscopic particles (referred to herein as metal-organic framework spheres). Following completion of the procedure, the metal-organic framework spheres were filtered and then washed with water and ethanol, and allowed to dry at room temperature.

Table 1 below provides the weight percent CaCl₂ and the wt. % of MOF in the slurry (referred to as “Wt.% MOF (wet)”). Table 1 also provides the wt. % MOF in the dried metal-organic sphere as “Wt.% MOF (dry)”. The metal-organic framework spheres were then analyzed for crush strength as provided in the last column of Table 1.

TABLE 1
Crush Strength Data Metal-Organic Spheres Made with
Aqueous Sodium Alginate and Calcium Chloride

| | | Wt. % | Wt. % | | Crush |
|---|---|---|---|---|---|
| | Comparative | MOF | MOF | Wt. % | Strength |
| Material | or Inventive | (wet) | (dry) | CaCl₂ | (lb_{force}) |
| Mg-MOF-74 | Comparative | — | — | — | 0.0 |
| Mg-MOF-74 | Inventive | 13.0 | 90.9 | 1.0 | 1.4 |
| Mg-MOF-74 | Inventive | 13.0 | 90.9 | 2.9 | 1.5 |
| Mg-MOF-74 | Inventive | 13.0 | 68.2 | 1.0 | 11.3 |
| Mg-MOF-74 | Inventive | 13.0 | 68.2 | 2.9 | 10.2 |
| Mg-MOF-74 | Inventive | 16.7 | 84.7 | 3.6 | 6.7 |
| Mg-MOF-274 | Comparative | — | — | — | 0.0 |
| Mg-MOF-274 | Inventive | 16.7 | 84.7 | 3.6 | 7.9 |
| UiO-66 | Comparative | — | — | — | 0.0 |
| UiO-66 | Inventive | 16.7 | 91.7 | 3.6 | 4.3 |

While MOF powders on their own have zero crush strength, it is clear that metal-organic framework spheres produced with this method provides an increased crush strength.

### Example 2: Metal-Organic Framework Spheres Containing High Surface Areas

Retained surface area of metal-organic frameworks used to make the metal-organic framework spheres made in Example 1 above was determined. As provided in Table 2 below, “Normalized Surface Area” refers to surface area per gram of metal-organic framework, and note total mass of the metal-organic framework sphere. The percent surface area retained is based on the normalized values. Table 2, last column.

TABLE 2
Surface Area Data Metal-Organic Spheres Made with
Aqueous Sodium Alginate and Calcium Chloride

| | | Wt. % | | | Normalized | % |
|---|---|---|---|---|---|---|
| | Comparative | MOF | Wt. % | Surface Area | Surface Area | Surface Area |
| Material | or Inventive | (dry) | CaCl₂ | (m²/g) | (m²/g) | Retained |
| Mg-MOF-74 | Comparative | — | — | 768 | — | — |
| Mg-MOF-74 | Inventive | 84.7 | 3.6 | 513 | 606 | 79 |
| UiO-66 | Comparative | — | — | 1112 | — | — |
| UiO-66 | Inventive | 91.7 | 3.6 | 1124 | 1226 | 110 |

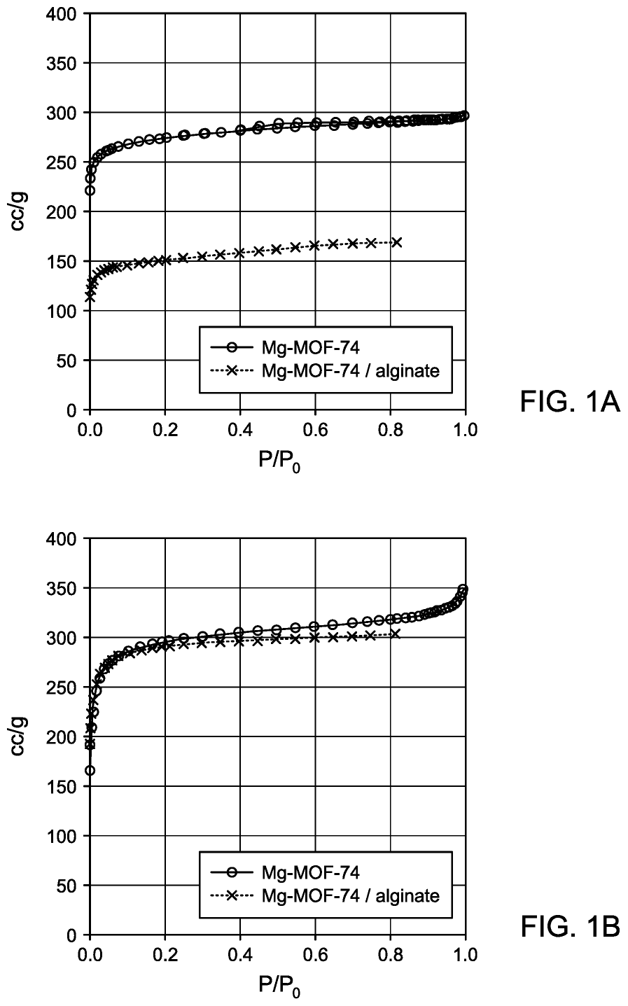

While surface area did decrease moderately for Mg-MOF-74 when formed with alginate (79% surface area retention), UiO-66 had a slight boost in surface area. FIG. 1A shows N₂ isotherms taken at 77 K of Mg-MOF-74 with and without sphere formation. FIG. 1B shows N₂ isotherms taken at 77 K of UiO-66 with and without sphere formation.

### Example 3: Metal Organic Framework Spheres Capable of Adsorbing CO₂

For the metal-organic framework methods used in Example 1, a series of experiments were conducted to demonstrate that that mmen-Mg-MOF-274 spheres are capable of adsorbing CO₂, similar to the remarkable mmen-Mg-MOF-274 (where mmen=N,N′-dimethylethylenediamine). The samples described in Table 3, each used a formulation to provide a metal-organic framework sphere comprising 91.7% metal-organic framework on a dry basis, and used calcium chloride solutions at 3.6 wt. %. Table 3 provides the percent CO₂ capacities based on theoretical capacity. The theoretical capacity of mmen-Mg-MOF-274 is a 17.78% mass increase where one CO₂ molecule is adsorbed per mmen-Mg moiety. Normalized values were based on a network of alginate complexes (and its associated polymers) that will not adsorb CO₂ (see Example 4). Specifically, when the metal-organic framework sphere comprises 91.7% metal-organic frameworks, the theoretical mass increase is 16.30% mass increases where one CO₂ molecule is adsorbed per mmen-Mg moiety.

In a temperature swing adsorption process, the gas to be adsorbed preferentially adsorbs at low temperature and does not adsorb or desorbs at high temperature. Ideally, a small temperature change would allow for energy efficient adsorption/desorption to occur.

As set out in Table 3 below, the percentage of CO₂ capacity is given at three temperatures (140° C., 120° C. and 40° C.). In Table 3, the quotient of % CO₂ capacity at 40° C. and 140° C. using normalized values when relevant are provided in the last column. This value is important, and ideally should be as large as possible. mmen-Mg-MOF-274 without alginate adsorbs 23.4 times as much CO₂ at 40° C. versus 140° C.

TABLE 3
CO₂ Adsorption with Metal-Organic Spheres Made with
Aqueous Sodium Alginate and Calcium Chloride

| | | % CO₂ | % CO₂ | % CO₂ | % CO₂ |
|---|---|---|---|---|---|
| | | capacity | capacity | capacity | capacity |
| | Comparative | at 140° C. | at 120° C. | at 40° C. | 40° C./ |
| MOF | or Inventive | (normalized) | (normalized) | (normalized) | 140° C. |
| MOF | Comparative | 3.9 | 17.4 | 88.9 | 23.4 |
| MOF/Alginate | Inventive | 11.8 (14.0) | 23.6 (28.1) | 50.6 (60.2) | 4.3 |
| Spheronized | | | | | |
| MOF/Alginate | Inventive | 3.9 (4.7) | 7.3 (8.7) | 57.9 (68.9) | 14.7 |
| Spheronized + | | | | | |
| mmen | | | | | |
| MOF/Alginate | Inventive | 4.5 (5.4) | 7.9 (9.4) | 69.7 (82.9) | 15.5 |
| Spheronized + | | | | | |
| mmen | | | | | |
| in Toluene | | | | | |

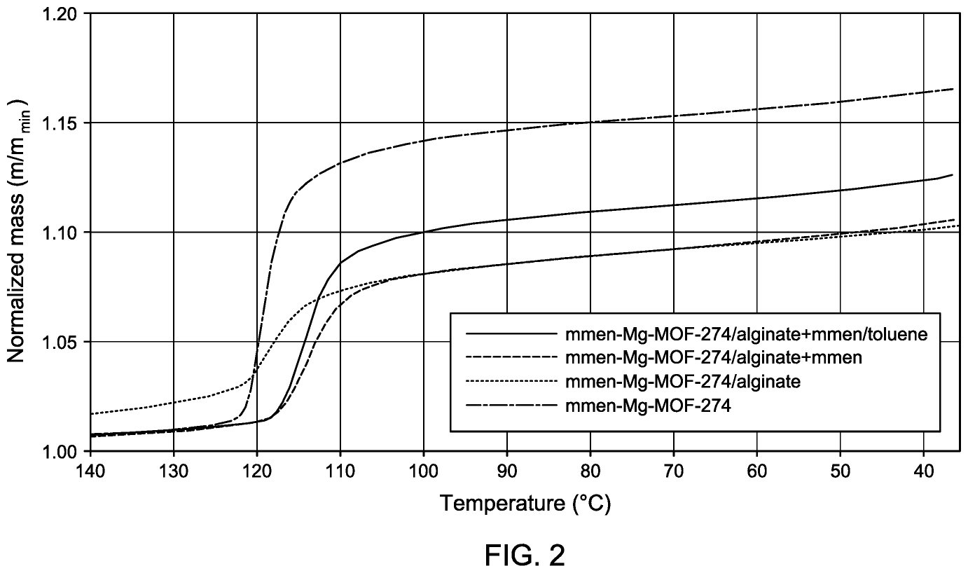

When mmen-Mg-MOF-274 is mixed with sodium alginate and calcium chloride (row 2 of Table 3 and FIG. 2) more CO₂ is adsorbed at high temperature and less at low temperature, resulting in a quotient of 4.3. This detrimental effect can be reversed (rows 3 and 4 of Table 3) by adding either neat mmen (row 3) or a solution of mmen in toluene (row 4) to the spheres. FIG. 2. This demonstrates, however, the ability of mmen-Mg-MOF-274 to be spheronized using sodium alginate/calcium chloride, and that the spheres formed are capable of adsorbing CO₂ in an energy efficient temperature swing adsorption process.

### Example 4: Various Methods Tested

We explored an alternative method of making the metal-organic framework sphere where the metal organic frameworks were mixed into an aqueous solution of calcium chloride, and then adding this mixture to the aqueous sodium alginate solution. 3.6 wt. % CaCl₂ solutions were used. Table 4 below indicates wt. % of metal-organic frameworks (dry basis) in the metal-organic framework sphere, and CO₂ capacity as a % weight gain.

TABLE 4
CO₂ Adsorption with Metal-Organic Spheres Made by Mixing
Metal-Organic Frameworks in a Calcium Chloride Solution

| | | | Wt. % | % Wt. gain |
|---|---|---|---|---|
| | Comparative | | MOF | capacity |
| MOF | or Inventive | Method | (dry) | at 40° C. |
| Alginate | Comparative | — | — | 0 |
| without MOF | | | | |
| mmen-Mg-MOF-274 | Comparative | Internal | 84.7 | 0 |
| Alginate Internal | | | | |
| mmen-Mg-MOF-274 | Inventive | External | 84.7 | 9 |
| Alginate External | | | | |
| mmen-Mg-MOF-274 | Inventive | External | 92.9 | 11 |
| Alginate External | | | | |

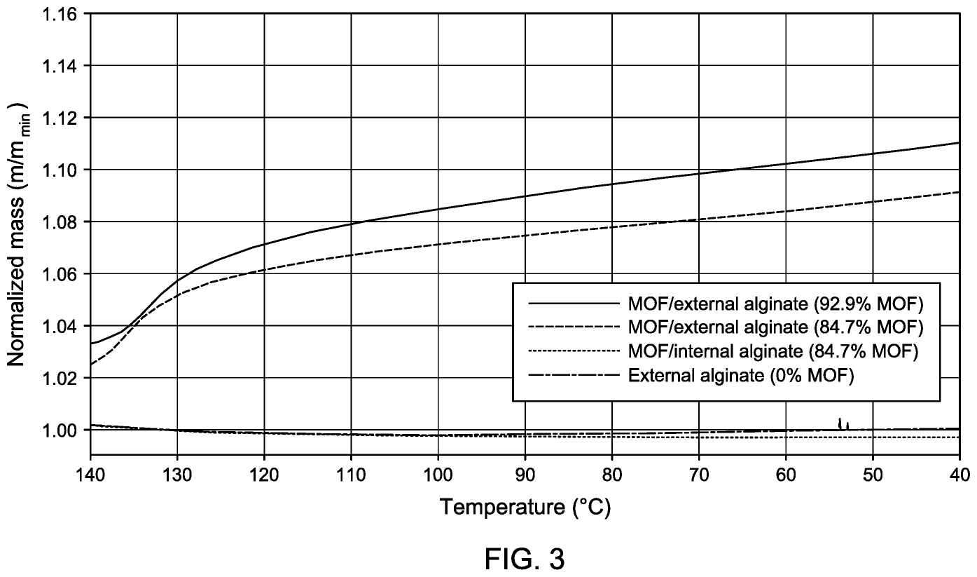

As shown by the data of Table 4 and in FIG. 3, a control sample without metal-organic frameworks will not adsorb any CO₂. Further, while this methodology produced metal-organic framework spheres, but spheres did not adsorb CO₂. On the other hand, using the method of Example 1, the metal-organic framework spheres adsorbed CO₂ based on the wt. % metal-organic framework in the metal-organic framework sphere.

When numerical lower limits and numerical upper limits are listed herein, ranges from any lower limit to any upper limit are contemplated. Although the present disclosure has been described in terms of specific aspects, it is not so limited. Suitable alterations/modifications for operation under specific conditions should be apparent to those skilled in the art. It is therefore intended that the following claims be interpreted as covering all such alterations/modifications as fall within the true spirit/scope of the disclosure.

Additionally or alternately, the invention relates to:

Embodiment 1. A composition comprising a plurality of metal-organic frameworks positioned within a network of calcium alginate complexes, prepared by combining an aqueous metal-organic framework alginate mixture with an aqueous solution of calcium chloride wherein the aqueous metal-organic framework alginate mixture comprises less than or equal to about 5.0 wt. %. sodium alginate, between about 1.0 wt. % and 5.0 wt. % calcium chloride, and at least 10 wt. % of metal-organic framework, each of the metal-organic frameworks comprises at least one metal ion and at least one organic ligand, wherein the composition comprises greater than or equal to 60 wt. % metal-organic frameworks and has a crush strength of at least about 10 lb. force and a surface area of at least about 500 m²/gram.

Embodiment 2. A metal-organic framework sphere comprising: between about 60 wt. % and about 70 wt. % metal-organic frameworks, each of the metal organic frameworks comprises an organic ligand and a metal, wherein the metal-organic frameworks are blended within a network of calcium alginate complexes, each complex having alginate ionically crosslinked with calcium, wherein the metal-organic framework sphere has a bulk crush strength at least 10 lb. force and a surface area of at least 500 m²/gram.

Embodiment 3. A method of making a metal-organic framework sphere comprising:
dissolving calcium chloride in water to produce a calcium chloride solution;
mixing sodium alginate and water to produce an aqueous sodium alginate solution;
adding metal-organic frameworks to the aqueous sodium alginate solution to produce an aqueous metal-organic framework alginate mixture, wherein each of the metal-organic frameworks has an organic ligand and a metal; and
adding the aqueous metal-organic framework alginate mixture to the calcium chloride solution to form the metal-organic framework sphere.

Embodiment 4. The method of embodiment 3, wherein the calcium chloride solution comprises at least 3.0 wt. % calcium chloride.

Embodiment 5. The method of embodiment 3 or 4, wherein the aqueous sodium alginate solution has a temperature of between 20° C. and 25° C.

Embodiment 6. The method of anyone of embodiments 3 to 5, wherein the aqueous metal-organic framework alginate mixture is a slurry.

Embodiment 7. The method of embodiment 6, wherein the slurry comprises at least 10 wt. % of metal-organic frameworks.

Embodiment 8. The method of embodiment 6 or 7, wherein the slurry is added dropwise to the calcium chloride solution.

Embodiment 9. A method of making a metal-organic framework sphere comprising the steps of:
mixing less than or equal to about 5.0 wt. % sodium alginate with water to produce an aqueous sodium alginate solution;
adding a plurality of metal-organic frameworks to the aqueous sodium alginate solution to produce an aqueous metal-organic framework alginate mixture, wherein each of the metal-organic frameworks has an organic ligand and a metal; and
adding the aqueous metal-organic framework alginate mixture to an aqueous calcium chloride solution comprising between about 2.0 wt. % and 5.0 wt. % calcium chloride to form a metal-organic framework sphere, e.g., to form about 15 wt. % or less of wet metal-organic frameworks in a metal-organic framework sphere.

Embodiment 10. The method of any one of embodiments 3 to 9, wherein the metal-organic framework sphere has a crush strength of at least 10 lb. force and a surface area of at least 500 m²/g.

Embodiment 11. The method of any one of embodiments 3 to 10, further comprising adding neat amines or a solution of amines in toluene to the metal-organic framework spheres.

Embodiment 12. The composition, metal-organic framework sphere, or method of any one of the preceding embodiments, wherein the organic ligand comprises one or more of:
an alkyl group substructure having from 1 to 10 carbon atoms; or
an aryl group substructure having from 1 to 5 aromatic rings; and
wherein the one or more substructures each have at least two X groups, and wherein X is a functional group configured to coordinate to a metal or metalloid.

Embodiment 13. The composition, metal-organic framework sphere, or method of anyone of the preceding embodiments, wherein each of the metal-organic frameworks comprises an organic ligand comprising an alkylamine substructure having from 1 to 10 carbon atoms or an arylamine or nitrogen-containing heterocycle substructure having from 1 to 5 aromatic rings; and wherein the substructure(s) each have at least two X groups, and wherein X is a functional group configured to coordinate to a metal or metalloid.

Embodiment 14. The composition, metal-organic framework sphere, or method of embodiment 12 or 13, where each X is independently selected from neutral or ionic forms of CO₂H, OH, SH, OH₂, NH₂, CN, HCO, CS₂H, NO₂, SO₃H, Si(OH)₃, Ge(OH)₃, Sn(OH)₃, Si(SH)₄, Ge(SH)₄, Sn(SH)₃, PO₃H, AsO₃H, AsO₄H, P(SH)₃, As(SH)₃, CH(RSH)₂, C(RSH)₃, CH(RNH₂)₂, C(RNH₂)₃, CH(ROH)₂, C(ROH)₃, CH(RCN)₂, C(RCN)₃, CH(SH)₂, C(SH)₃, CH(NH₂)₂, C(NH₂)₂, CH(OH)₂, C(OH)₃, CH(CN)₂, C(CN)₃, nitrogen-containing heterocycles, sulfur-containing heterocycles, or combination(s) thereof, wherein R is an alkyl group having from 1 to 5 carbon atoms or an aryl group of 1 to 2 phenyl rings.

Embodiment 15. The composition, metal-organic framework sphere, or method of anyone of the preceding embodiments, wherein the organic ligand is selected from 1,3,5-benzenetricarboxylate, 1,4-benzenedicarboxylate, 1,3-benzenedicarboxylate, biphenyl-4,4′-dicarboxylate, benzene-1,3,5-tris(1H-tetrazole), acetylene-1,2-dicarboxylate, naphtalenedicarboxylate, adamantanetetracarboxylate, benzenetribenzoate, methanetetrabenzoate, adamantanetribenzoate, biphenyl-4,4′-dicarboxylate, imidazole, 2,5-dihydroxy-1,4-benzendicarboxylic acid, 4,4′-dihydroxy-(1,1′-biphenyl)-3,3′-dicarboxylic acid derivatives thereof, or combination(s) thereof.

Embodiment 16. The composition, metal-organic framework sphere, or method of anyone of the preceding embodiments, wherein each of the metal-organic framework comprises a metal ion selected from Be²⁺, Mg²⁺, Ca²⁺, Sr²⁺, Ba²⁺, Sc³⁺, Y³⁺, Ti⁴⁺, Zr⁴⁺, Hf⁴, V⁴⁺, V³⁺, V²⁺, Nb³⁺, Ta³⁺, Cr³⁺, Mo³⁺, W³⁺, Mn³⁺, Mn²⁺, Re³⁺, Re²⁺, Fe³⁺, Fe²⁺, Ru³⁺, Ru²⁺, Os³⁺, Os²⁺, Co³⁺, Co²⁺, Rh²⁺, Rh⁺, Ir²⁺, Ir⁺, Pd²⁺, Pd⁺, Pt²⁺, Pt⁺, Cu²⁺, Cu⁺, Ag⁺, Au⁺, Zn²⁺, Cd²⁺, Hg²⁺, Al³⁺, Ga³⁺, In³⁺, Tl³⁺, Si⁴⁺, Si²⁺, Ge⁴⁺, Ge²⁺, Sn⁴⁺, Sn²⁺, Pb⁴⁺, Pb²⁺, As⁵⁺, As³⁺, As⁺, Sb⁵⁺, Sb³⁺, Sb⁺, and Bi⁵⁺, Bi³⁺, Bi⁺, or combination(s) thereof.

Embodiment 17. The composition, metal-organic framework sphere, or method of embodiment 16, wherein the metal ion is selected from Mg²⁺, Mn³⁺, Mn²⁺, Fe³⁺, Fe²⁺, Co³⁺, Co²⁺, Cu²⁺, Cu⁺, Pt²⁺, Ag⁺, Zn²⁺, Zr⁴⁺, Hf⁴⁺, or combination(s) thereof.

Embodiment 18. The composition, metal-organic framework sphere, or method of anyone of the preceding embodiments, wherein each of the metal-organic frameworks is selected from Mg-MOF-74, HKUST-1, UiO-66, ZIF-8, ZIF-7, MIL-100, Mg-MOF-274, mixed metal organic frameworks, and/or combination(s) thereof.

Embodiment 19. The composition, metal-organic framework sphere, or method of any one of the preceding embodiments, wherein the metal-organic framework is UiO-66, Mg-MOF-74, or amine-MOF-274.

Embodiment 20. The composition, metal-organic framework sphere, or method of any one of the preceding embodiments, wherein the metal-organic framework sphere is capable of absorbing CO₂ in an energy efficient temperature swing adsorption process.

1-20. (canceled)

21. A metal-organic framework sphere comprising:
between about 60 wt. % and about 70 wt. % metal-organic frameworks, each of the metal organic frameworks comprises an organic ligand and a metal, wherein the metal-organic frameworks are blended within a network of calcium alginate complexes, each complex having alginate ionically crosslinked with calcium, wherein the metal-organic framework sphere has a bulk crush strength at least 10 lb. force and a surface area of at least 500 m²/gram.

22. A method of making a metal-organic framework sphere comprising:
dissolving calcium chloride in water to produce a calcium chloride solution;
mixing sodium alginate and water to produce an aqueous sodium alginate solution;
adding metal-organic frameworks to the aqueous sodium alginate solution to produce an aqueous metal-organic framework alginate mixture, wherein each of the metal-organic frameworks has an organic ligand and a metal; and
adding the aqueous metal-organic framework alginate mixture to the calcium chloride solution to form the metal-organic framework sphere.

23. The method of claim 22, wherein the calcium chloride solution comprises at least 3.0 wt. % calcium chloride.

24. The method of claim 22, wherein the aqueous sodium alginate solution has a temperature of between 20° C. and 25° C.

25. The method of claim 22, wherein the aqueous metal-organic framework alginate mixture is a slurry.

26. The method of claim 25, wherein the slurry comprises at least 10 wt. % of metal-organic frameworks.

27. The method of claim 25, wherein the slurry is added dropwise to the calcium chloride solution.

28. The method of claim 22 comprising the steps of:
mixing less than or equal to about 5.0 wt. % sodium alginate with water to produce an aqueous sodium alginate solution;
adding a plurality of metal-organic frameworks to the aqueous sodium alginate solution to produce an aqueous metal-organic framework alginate mixture, wherein each of the metal-organic frameworks has an organic ligand and a metal; and
adding the aqueous metal-organic framework alginate mixture to an aqueous calcium chloride solution comprising between about 2.0 wt. % and 5.0 wt. % calcium chloride to form a metal-organic framework sphere.

29. The method of claim 22, wherein the metal-organic framework sphere has a crush strength of at least 10 lb. force and a surface area of at least 500 m²/g.

30. The method of claim 22, further comprising adding neat amines or a solution of amines in toluene to the metal-organic framework spheres.

31. The metal-organic framework sphere of claim 21, wherein the organic ligand is selected from 1,3,5-benzenetricarboxylate, 1,4-benzenedicarboxylate, 1,3-benzenedicarboxylate, biphenyl-4,4′-dicarboxylate, benzene-1,3,5-tris(1H-tetrazole), acetylene-1,2-dicarboxylate, naphtalenedicarboxylate, adamantanetetracarboxylate, benzenetribenzoate, methanetetrabenzoate, adamantanetribenzoate, biphenyl-4,4′-dicarboxylate, imidazole, 2,5-dihydroxy-1,4-benzendicarboxylic acid, 4,4′-dihydroxy-(1,1′-biphenyl)-3,3′-dicarboxylic acid derivatives thereof, or combination(s) thereof.

32. The metal-organic framework sphere of claim 21, wherein the metal ion is selected from Mg²⁺, Mn³⁺, Mn²⁺, Fe³⁺, Fe²⁺, Co³⁺, Co²⁺, Cu²⁺, Cu⁺, Pt²⁺, Ag⁺, Zn²⁺, Zr⁴⁺, Hf⁴⁺, or combination(s) thereof.

33. The metal-organic framework sphere of claim 21, wherein each of the metal-organic frameworks is selected from Mg-MOF-74, HKUST-1, UiO-66, ZIF-8, ZIF-7, MIL-100, Mg-MOF-274, mixed metal organic frameworks, and/or combination(s) thereof.

34. The metal-organic framework sphere of claim 21, wherein the metal-organic framework is UiO-66, Mg-MOF-74, or amine-MOF-274.

35. The metal-organic framework sphere of claim 21, wherein the metal-organic framework sphere is capable of absorbing CO₂ in an energy efficient temperature swing adsorption process.

36. The method of claim 22, wherein the organic ligand is selected from 1,3,5-benzenetricarboxylate, 1,4-benzenedicarboxylate, 1,3-benzenedicarboxylate, biphenyl-4,4′-dicarboxylate, benzene-1,3,5-tris(1H-tetrazole), acetylene-1,2-dicarboxylate, naphtalenedicarboxylate, adamantanetetracarboxylate, benzenetribenzoate, methanetetrabenzoate, adamantanetribenzoate, biphenyl-4,4′-dicarboxylate, imidazole, 2,5-dihydroxy-1,4-benzendicarboxylic acid, 4,4′-dihydroxy-(1,1′-biphenyl)-3,3′-dicarboxylic acid derivatives thereof, or combination(s) thereof.

37. The method of claim 22, wherein the metal ion is selected from Mg²⁺, Mn³⁺, Mn²⁺, Fe³⁺, Fe²⁺, Co³⁺, Co²⁺, Cu²⁺, Cu⁺, Pt²⁺, Ag⁺, Zn²⁺, Zr⁴⁺, Hf⁴⁺, or combination(s) thereof.

38. The method of claim 22, wherein each of the metal-organic frameworks is selected from Mg-MOF-74, HKUST-1, UiO-66, ZIF-8, ZIF-7, MIL-100, Mg-MOF-274, mixed metal organic frameworks, and/or combination(s) thereof.

39. The method of claim 22, wherein the metal-organic framework is UiO-66, Mg-MOF-74, or amine-MOF-274.

40. The method of claim 22, wherein the metal-organic framework sphere is capable of absorbing CO₂ in an energy efficient temperature swing adsorption process.
